(19) United States
(12) Patent Application Publication
(10) Pub. No.: US 2002/0019256 A1
(43) Pub. Date: Feb. 14, 2002

(54) SECURITY SYSTEM FOR USED GAMING EQUIPMENT

(76) Inventors: THOMAS D. BENNETT, BILOXI, MI (US); JAMES J. RICHARDELLE, LONG BEACH, MI (US)

Correspondence Address: VENABLE BAETJER HOWARD & CIVILETTI LLP, 1201 NEW YORK AVENUE NW, SUITE 1000, WASHINGTON, DC, 20005

(21) Appl. No.: 09/362,679

(22) Filed: Jul. 29, 1999

(51) Int. Cl. A63F 9/24; A63F 13/00

(52) U.S. Cl. 463/29

(57) ABSTRACT

An accountability system for a casino game includes a plurality of playing cards, for example from one to eight decks of fifty-two playing cards, each of which have been used in the casino game, a label having first indicia to indicate receipt of the plurality of playing cards, and second indicia, coupled to the label and the plurality of playing cards, to indicate an attempt to tamper with one or more of the plurality of playing cards. Such accountability system can also be used in a similar manner for a stick of dice.

### BACKGROUND OF THE INVENTION

1. Field of the Invention

The present invention relates generally to casino games, and more particularly to methods and apparatus for maintaining accountability of equipment (e.g., playing cards and dice) used in such casino games.

2. Statement of the Prior Art

The legal gaming industry has enjoyed extraordinary growth both in the United States and abroad. It has been estimated, for example, that from 1982 to 1996 the domestic gaming industry experienced a compound annual growth rate of 11.2%, to $47.6 billion in revenues. Moreover, the percentage of households from which someone visited a casino to gamble increased from 17% in 1990 to 32% in 1996, representing over 36 million households and 176 million visits, according to Harrah's 1997 Survey of Casino Entertainment.

This increase in gaming demand results in part from the greater public acceptance of legal casino gaming. For example, research conducted by Yankelovich Partners, Inc. in 1996 found that 92% of U.S. adults view casino gambling as an acceptable form of entertainment for themselves and others. This acceptance is reflected not only by the dramatic number of domestic jurisdictions in which casino gaming under one form or the other is now permitted, but also by the many foreign jurisdictions which have either legalized casino gaming or expanded it in scope in the recent past. Significant foreign gaming jurisdictions now include Canada, Australia, New Zealand, France, The Netherlands, and various South American, Asian and Eastern European nations.

Much of the revenues derived from such legalized casino gaming comes as a result of card games, such as Baccarat, Blackjack, Caribbean Stud™ (a trademark of Progressive Games, Inc.), as well as many other forms of Poker. The playing cards typically used in such games vary in quality, from inexpensive import cards, to those manufactured from special fiber paper and plastic with a high-quality linen finish, to those which many consider to be the top of the line—cellulose acetate playing cards manufactured by Kem. These cards can be repeatedly washed and are made out of a very tough flexible plastic. However, in the major casinos of Nevada and New Jersey, most casino cards are changed every four hours whether those cards have been played or not. Keeping track of such cards can be difficult, but is a necessity in order to prevent the introduction of “marked” cards and other forms of nefarious schemes.

Accordingly, a principal object of the present invention is to provide unique improvements to existing methods for maintaining accountability of those playing cards used in casino games.

The most common approach now used for such purposes is “evidence bags”. Playing cards coming from the casino floor are collected together and placed in these evidence bags, treated much the same as criminal evidence in police investigations. Unfortunately, this approach is expensive, inefficient, cumbersome, difficult to monitor, and difficult to store.

Accordingly, it is another principal object of the present invention to provide methods and apparatus for maintaining accountability of used gaming equipment such as playing cards and dice while, at the same time, maximizing efficiency and minimizing expenses related to such accountability.

### SUMMARY OF THE INVENTION

An accountability system according to the present invention generally comprises used equipment from a casino game, a label, including first means for indicating receipt of the used equipment, and second means, coupled to the label and the used equipment, for indicating an attempt to tamper with such used equipment. The used equipment may be a plurality of playing cards, for example from one to eight decks of fifty-two playing cards each, or a “stick” of dice. As is well known, a stick of dice refers to a collection of from ten to twelve conventional dice that have been used in a casino game such as Craps.

In accordance with a presently preferred embodiment of this invention, the label further comprises third means for indicating a forwarding of the plurality of playing cards. The second indicating means is suitably comprised of any known tamper-proof or tamper indicating films, tapes, and foils, such as a transparent, tamper-resistant, pressure sensitive tape or a hot stamp foil. Such second indicating means may further comprise an optically variable device such as a holographic image, one or more authentication means selected from the group consisting of security laminates, security microdots, and security microthreads.

It is also preferred that the second indicating means comprises a tape including a backing material selected from the group consisting of polyester and polypropylene, and an adhesive selected from the group consisting of a hot melt rubber resin and an acrylic. More preferably, such backing material is clear, and resistant to things such as score line breaking, center seam splitting, tear and abrasion, aging, and ultraviolet light. Even more preferably, the second indicating means comprises a cold seal, pressure sensitive tape.

In any case, the first indicating means suitably comprises means for identifying events such as a date of receipt of the used gaming equipment, a time of receipt of the used gaming equipment, a shift number, a game title, first means for naming of a dealer of the game, second means for naming a pit manager of the game, a floor number, and an employee number of the casino employee receiving the used gaming equipment and accounting for same. The label of the accountability system according to the present invention may further comprise third means for indicating a forwarding of the used gaming equipment, such third indicating means comprising means for identifying events such as a date of the forwarding of the used gaming equipment, a time of the forwarding of the used gaming equipment, a shift number, a game title, first means for naming of a dealer of the game, second means for naming a pit manager of the game, a floor number, and an employee number of the casino employee receiving the used gaming equipment and accounting for same.

This invention, thus, conveniently provides methods and apparatus for maintaining accountability of used gaming equipment (e.g., playing cards and dice) while, at the same time, maximizing efficiency and minimizing expenses related to such accountability.

The above and other objects, advantages, and novel features according to the present invention will become more apparent from the following detailed description thereof, when considered in conjunction with the accompanying drawings wherein:

### BRIEF DESCRIPTION OF THE DRAWINGS

FIG. 1 illustrates the security system for used gaming equipment according to the present invention;

FIG. 2(a) is a perspective view of the security system shown in FIG. 1 as applied to a single box containing a plurality of playing cards comprising a deck;

FIG. 2(b) is a perspective view of the security system shown in FIG. 1 applied to a plurality of boxes, each of which contains a deck of playing cards; and

FIG. 3 illustrates a sheet of the security labels shown in FIGS. 1 and 2.

### DETAILED DESCRIPTION OF THE INVENTION

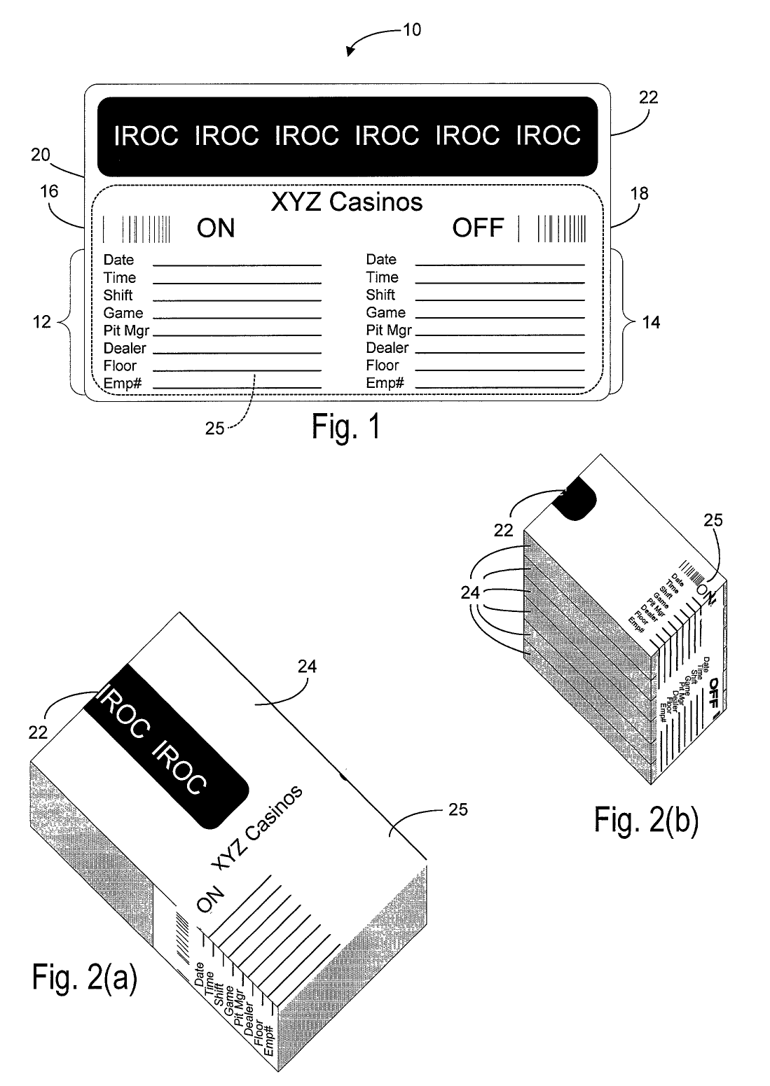

Referring now to the drawings, wherein like or corresponding parts are designated by the same or similar reference number throughout the several views, there is shown in FIG. 1 a security or accountability system for used gaming equipment which includes a label 10 according to the present invention. Such gaming equipment as illustrated herein comprises a plurality of standard playing cards, for example from one to eight decks of fifty-two cards each.

As is conventional, such playing cards typically come in a poker size (2½ inches wide by 3½ inches tall) and a bridge size (2¼ inches wide by 3½ inches tall), and are contained within a box 24 as shown in FIGS. 2(a) and 2(b). They may be made of any number of materials, including those used in inexpensive import cards, special fiber paper and plastic with a high-quality linen finish, or even 100% plastic, such as the washable, cellulose acetate playing cards manufactured by KEM Plastic Playing Cards, Inc. of Scranton, Pa.

Other forms of used gaming equipment, such as a “stick” of casino grade dice, may be accounted for with security system 10. Regardless of the materials used in such gaming equipment, security system 10 is adapted to be easily used, quickly applied, and securely maintained. Storage of such used gaming equipment is made easier by avoiding the use of bulky, known methods of accounting for such equipment, such as evidence bags. Furthermore, attempts at tampering with the used gaming equipment are made readily apparent through use of security label 10 that incorporates tamper-indicating means.

Referring again to FIGS. 1, 2(a) and 2(b), the accountability system according to the present invention generally comprises used equipment from a casino game (e.g., a plurality of playing cards 24, stick of dice, etc.), a label 10, including first means 12 for indicating receipt of the used equipment 24, and second means (not shown), coupled to the label 10 and the used equipment 24, for indicating an attempt to tamper with such used equipment 24. One manner of providing such first and second indicating means, is a two-part label 10 generally comprising one facing surface upon which written indicia can be made, and another obverse surface including a suitable adhesive. Another manner of providing such first and second indicating means is a two-part system made up of label 10, as shown in FIG. 1, and a transparent, tamper-indicating means wrapped around the used gaming equipment 24 to hold the label 10 in place thereon in the manner shown in FIGS. 2(a) and 2(b).

In accordance with a presently preferred embodiment of this invention, label 10 further comprises third means 14 for indicating a forwarding of the plurality of playing cards. Such third means 14 may suitably comprise the same or similar information as the first means 12, as long as one or both contain sufficient information to account for the use and location of gaming equipment 24. Further indicia, such as alphanumeric or bar-coded tracking information 16, 18 may be used to help automate the inventory and storage of the used gaming equipment 24. Moreover, label 10 can also include indicia 20 of the particular casino or gaming establishment in which the gaming equipment is used, as well as further indicia 22 of the manufacturer of such labels 10, wherein such indicia 22 also comprises the second part of the two-part security label according to the present invention. According to another important aspect of the present invention, each of the aforementioned indicia 12, 14, 16, 18, 20, and 22 may also comprise authentication means to assure the user of such accountability or security system that label 10 is valid. Exemplary of suitable such authentication means are the foils, laminates, microdots, and microthreads available from Optical Security Group, Inc., as well as other known means, such as optically variable devices including holographic images. Similarly suitable authentication means for label 10 comprise retroreflective labels, such as those sold by Minnesota Mining & Manufacturing (i.e., “3M”). As is known, these retroreflective labels, when viewed with an inexpensive battery-operated verifier, makes tampering easy to see. A broken seal, even if lined up exactly, will be revealed as a thin black line, and clear tape applied over a seal will nullify the retroreflective optical pattern.

It is also preferred that the second indicating means comprises a tape including a backing material selected from the group consisting of polyester and polypropylene, and an adhesive selected from the group consisting of a hot melt rubber resin and an acrylic. Such backings, as is well known, are often resistant to things such as score line breaking, center seam splitting, tear and abrasion, aging, and ultraviolet light. They conform to the shape of the items taped, and they are durable. Because of the nature of their use in an accountability or security system according to the present invention, such backing materials should be transparent or clear. Furthermore, an even more preferably, the second indicating means comprises a cold seal, pressure sensitive tape to avoid having to use any expensive and otherwise unnecessary hot sealing apparatus. Various examples of suitable such tapes are those manufactured by 3M, including all those using Scotchpar™ (a trademark of 3M) and Scotchpro™ (a trademark of 3M) backings, as well as acrylic and hot melt rubber resin adhesives.

One particularly good pressure sensitive tape is 3M's 3130 Cold Seal™ (a trademark of 3M). Its clear color will not distort or cloud. Furthermore, its combined controlled adhesion with specific film properties makes it an ideal choice for packaging a wide variety of small items such as playing cards and dice. The tape sticks to itself, not the item being packaged. Its transparent backing allows inspection without having to break the seal, and thereby reduces labor costs and potential rework. Because it bonds to itself and not the packaged product, it is also conveniently tamper-resistant. As a result, the two-part accountability or security system according to another embodiment of the present invention may simply comprise a label 10 having the indicia noted in FIG. 1, which is placed on the used gaming equipment 24 and, together, secured by wrapping the label 10 and gaming equipment 24 with such cold seal, pressure sensitive tape.

In any case, the first indicating means 12 as shown in FIG. 1 suitably comprises means for identifying one or more events such as a date of receipt of the used gaming equipment, a time of receipt of the used gaming equipment, a shift number, a game title, first means for naming of a dealer of the game, second means for naming a pit manager of the game, a floor number, and an employee number of the casino employee receiving the used gaming equipment and accounting for same. Likewise, label 10 may further comprise third means 14 for indicating a forwarding of the used gaming equipment, such third indicating means similarly comprising means for identifying one or more events such as a date of the forwarding of the used gaming equipment, a time of the forwarding of the used gaming equipment, a shift number, a game title, first means for naming of a dealer of the game, second means for naming a pit manager of the game, a floor number, and an employee number of the casino employee receiving the used gaming equipment and accounting for same.

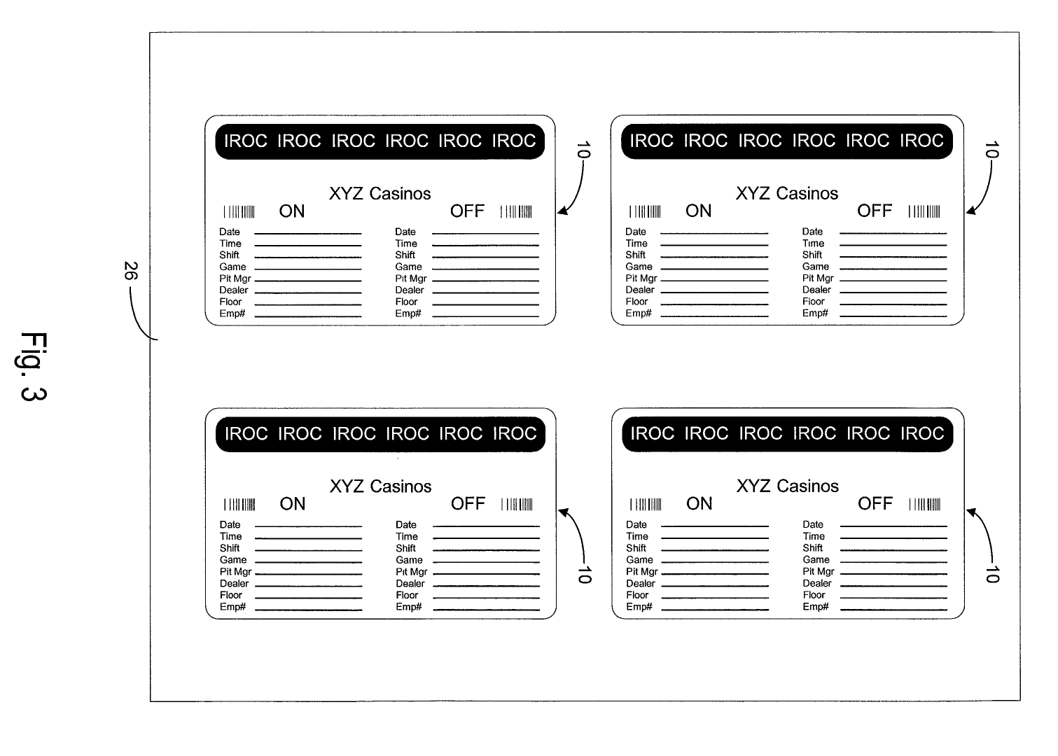

Referring now to FIG. 3, there is shown a sheet 26 of printed labels 10 according to another embodiment of the present invention. Such sheets 26 may be pre-printed or printed on demand with the aid of any electrophotographic printer. Die cut label stock with tamper-proof adhesives (e.g., those which leave a “void” image if someone tries to remove the label) are readily available from manufacturers such as 3M, Fasson, and Flexcon. Moreover, such label stock can be formed of a variety of pressure-sensitive materials, including paper, fluorescent, vinyl, aluminum, polyesters, clear acetate, latex, and computer imprintable materials. They can converted into piggyback constructions, continuous pinfeeds, fanfold construction, or individual sheets such as sheet 26 shown in FIG. 3. One source of such suitable labels is Northeast Quality Products of Newburyport, Mass.

Obviously, many modifications and variations of the security system according to the present invention are possible when viewed in light of the foregoing teachings. For example, any number of tamper-indicating means can be combined with the label 10 to further heighten its secure nature. Moreover, any number of adhesives would be suitable for such two-part labels 10, as long as they were adaptable to the surface of the particular gaming equipment so secured. Moreover, the two-part security label according to the present invention may simply comprise a first major, peel-off portion 25 which includes tracking indicia, and a second minor, peel-off portion 22 which is affixed to the particular used gaming equipment 24. Such second peel-off portion 22 could further include duplicate indicia such as the bar coding 16, 18 found on its associated major portion 25.

As shown in FIG. 2(a), the first peel-off portion 25 is adhered to the box 24 of playing cards in a lateral arrangement. Second peel-off portion 22 is adhered across the top of the box 24 to seal its flap shut and thereby securely contain the playing cards therein. A plurality of decks of playing cards may be secured as shown in FIG. 2(b). The second peel-off portion 22 is adhered across the tops of the boxes 24 containing the playing cards to seal their flaps shut. In this embodiment, the first peel-off portion 25 is preferably adhered to the bottoms of the boxes 24. Of course, the system according to the present invention may be used to secure a plurality of cards not contained within a box.

It should be understood, therefore, that all such modifications and variations could be used in accordance with the present invention and would, thus, be deemed to fall within the scope of the appended claims. W

hat we claim as our invention is:

1. An accountability system for a casino game, comprising:
a plurality of playing cards, each of which have been used in the casino game;
a label, including first means for indicating a receipt of said plurality of playing cards; and
second means, coupled to said label and said plurality of playing cards, for indicating an attempt to tamper with one or more of said plurality of playing cards.

2. The accountability system according to claim 1, wherein said label further comprises third means for indicating a forwarding of said plurality of playing cards.

3. The accountability system according to claim 1, wherein said second indicating means comprises a transparent, tamper-resistant, pressure sensitive tape.

4. The accountability system according to claim 1, wherein said second indicating means comprises a hot stamp foil.

5. The accountability system according to claim 4, wherein said second indicating means further comprises an optically variable device.

6. The accountability system according to claim 5, wherein said optically variable device comprises a holographic image.

7. The accountability system according to claim 1, wherein said second indicating means further comprises one or more authentication means selected from the group consisting of security laminates, security microdots, and security microthreads.

8. The accountability system according to claim 1, wherein said second indicating means comprises a tape including a backing material selected from the group consisting of polyester and polypropylene, and an adhesive selected from the group consisting of a hot melt rubber resin and an acrylic.

9. The accountability system according to claim 8, wherein said backing material is clear.

10. The accountability system according to claim 8, wherein said backing material is resistant to one or more of the following properties: score line breaking, center seam splitting, tear and abrasion, aging, and ultraviolet light.

11. The accountability system according to claim 1, wherein said second indicating means comprises a cold seal, pressure sensitive tape.

12. The accountability system according to claim 1, wherein said first indicating means comprises means for identifying one or more of the following: a date of receipt of said plurality of playing cards, a time of receipt of said plurality of playing cards, a shift number, a game title, first means for naming of a dealer of said game, second means for naming a pit manager of said game, a floor number, and an employee number of the casino employee receiving said plurality of playing cards and accounting for same.

13. The accountability system according to claim 12, wherein said label further comprises third means for indicating a forwarding of said plurality of playing cards, said third indicating means comprises means for identifying one or more of the following: a date of said forwarding of said plurality of playing cards, a time of said forwarding of said plurality of playing cards, a shift number, a game title, first means for naming of a dealer of said game, second means for naming a pit manager of said game, a floor number, and an employee number of the casino employee receiving said plurality of playing cards and accounting for same.

14. An accountability system for a casino game, comprising:
a plurality of dice, each of which have been used in the casino game;
a label, including first means for indicating a receipt of said plurality of dice; and
second means, coupled to said label and said plurality of dice, for indicating an attempt to tamper with one or more of said plurality of dice.

15. The accountability system according to claim 14, wherein said label further comprises third means for indicating a forwarding of said plurality of dice.

16. The accountability system according to claim 14, wherein said second indicating means comprises a transparent, tamper-resistant, pressure sensitive tape.

17. The accountability system according to claim 14, wherein said second indicating means comprises a hot stamp foil.

18. The accountability system according to claim 17, wherein said second indicating means further comprises an optically variable device.

19. The accountability system according to claim 18, wherein said optically variable device comprises a holographic image.

20. The accountability system according to claim 14, wherein said second indicating means further comprises one or more authentication means selected from the group consisting of security laminates, security microdots, and security microthreads.

21. The accountability system according to claim 14, wherein said second indicating means comprises a tape including a backing material selected from the group consisting of polyester and polypropylene, and an adhesive selected from the group consisting of a hot melt rubber resin and an acrylic.

22. The accountability system according to claim 21, wherein said backing material is clear.

23. The accountability system according to claim 21, wherein said backing material is resistant to one or more of the following properties: score line breaking, center seam splitting, tear and abrasion, aging, and ultraviolet light.

24. The accountability system according to claim 14, wherein said second indicating means comprises a cold seal, pressure sensitive tape.

25. The accountability system according to claim 14, wherein said first indicating means comprises means for identifying one or more of the following: a date of receipt of said plurality of dice, a time of receipt of said plurality of dice, a shift number, a game title, first means for naming of a dealer of said game, second means for naming a pit manager of said game, a floor number, and an employee number of the casino employee receiving said plurality of dice and accounting for same.

26. The accountability system according to claim 25, wherein said label further comprises third means for indicating a forwarding of said plurality of dice, said third indicating means comprises means for identifying one or more of the following: a date of said forwarding of said plurality of dice, a time of said forwarding of said plurality of dice, a shift number, a game title, first means for naming of a dealer of said game, second means for naming a pit manager of said game, a floor number, and an employee number of the casino employee receiving said plurality of dice and accounting for same.

27. A method of securing gaming equipment which has been used in a casino game, comprising the steps of:
collecting the used gaming equipment;
providing a two-part label, including first means for indicating a receipt of said plurality of dice; and
coupling to said label and the used gaming equipment, a second means for indicating an attempt to tamper with the used gaming equipment.

28. The method according to claim 27, further comprising the steps of:
selecting a means for identifying one or more of the following: a date of receipt of said used gaming equipment, a time of receipt of said used gaming equipment, a shift number, a game title, first means for naming of a dealer of said game, second means for naming a pit manager of said game, a floor number, and an employee number of the casino employee receiving said used gaming equipment and accounting for same; and
applying said selected means to said label as said first indicating means.

29. The method according to claim 27, further comprising the steps of:
providing a third means for indicating a forwarding of the used gaming equipment;
selecting a means for identifying one or more of the following: a date of said forwarding of said used gaming equipment, a time of said forwarding of said used gaming equipment, a shift number, a game title, first means for naming of a dealer of said game, second means for naming a pit manager of said game, a floor number, and an employee number of the casino employee receiving said used gaming equipment and accounting for same; and
applying said selected means to said label as said third indicating means.
